(19) United States
(12) Patent Application Publication
(10) Pub. No.: US 2024/0154497 A1
(43) Pub. Date: May 9, 2024

(54) ECOSYSTEM PRESSURE SYSTEM

(71) Applicant: DONALD LEE ADLE, Clearwater, FL (US)

(72) Inventor: DONALD LEE ADLE, Clearwater, FL (US)

(21) Appl. No.: 17/981,845

(22) Filed: Nov. 7, 2022

(51) Int. Cl. H02K 7/18; H02J 7/14

(52) U.S. Cl. CPC H02K 7/1823; H02J 7/14

(57) ABSTRACT

Ecosystem Pressure System: Battery—motor—motor axis—air return housing—air tube housing—blade compressor—blade tube convergent-divergent pinched in the middle—compressor hub—hub tube—housing air pressure—tube compressor convergent-divergent pinched in the middle—nozzle compressor convergent-divergent pinched in the middle—gas tube—generator axis—pressure air channel—generator—generator motor—generator motor axis.

### STATEMENT REGARDING FEDERALLY SPONSORED RESEARCH OR DEVELOPMENT

Not applicable.

### CROSS-REFERENCE TO RELATED APPLICATIONS

Not applicable.

### INDUSTRIAL APPLICABILITY

Ecosystem Pressure System also known as apparatus. Each apparatus has its own operating operator system. Apparatus has a charging system, electric system, and generator system, driving system, a non-polluting system. Mixed it all together, and you've got an apparatus. The center of a tornado is characterized by low pressure, which is typically 10-20 percent lower than the surrounding air pressure. This pressure differential occurs over a very short distance, resulting in a large pressure gradient force that generates high wind speeds. Mixed it all together, and you've got an apparatus.

Ecosystem Pressure System a non-polluting system. Vehicles, building, machines. Meeting all requirements by any regulatory body and in accordance with any regulations that impacting the polluting of the air industry. Making this: Vehicle, building, machine, one ecosystem management system.

FIELD OF: Generator, Motor, Battery

In an AC generator, the electrical current reverses direction periodically. In a DC generator, the electrical current flows only in one direction. Generator 34, AC or DC with means to produce electrical energy and control amount of electric used.

The charging current is controlled by a switch or transistor connected in parallel with the photovoltaic panel and the storage battery. Overcharging of the battery is prevented by shorting (shunting) the PV output through the transistor when the voltage reaches a predetermined limit. Battery when connected into a circuit converts potential chemical directly into kinetic electrical energy.

The two main methods used to charge batteries are constant current charging and constant voltage charging. The method used depends on the characteristics of the battery. In constant voltage charging, the charger voltage is held constant.

The speed of a DC motor can be controlled by changing the flux applied to it as the speed of the motor is inversely proportional to the flux per pole. To control the flux, a variable resistor or a rheostat is added in series with the field winding. While your electric car motor uses AC, the battery needs to receive its electricity in DC. A conversion from alternative to direct current, either onboard or outside the vehicle, is therefore required.

The speed of the single phase-induction motor can also be controlled by employing tapped exciting winding, so that the constant voltage source may be impressed across the entire winding or some part of it. By this means, a normal speed and a single reduced speed are provided.

FIELD OF: Convergent-Divergent Nozzle, Compressors

Convergent-divergent nozzle, CD nozzle or con-di nozzle) is a tube which is pinched in the middle, making a carefully balanced back pressure causing the gas stream to accelerate. It is used to accelerate a compressible fluid to supersonic speeds in the axial (thrust) direction, by converting the thermal energy of the flow into kinetic energy. Convergent-divergent nozzle are widely used in some types of steam turbines and turbines and rocket engine nozzlesturbines and rocket engine nozzles. It also uses in supersonic jet engines. Component: Blade tube 16 being convergent-divergent pinched in the middle, tube compressor 24 being convergent-divergent pinched in the middle, and nozzle compressor 26 being convergent-divergent pinched in the middle, are convergent-divergent nozzles.

Compressors have typically been used for a variety of inventions, such as air compression, vapor compression for refrigeration, and compression of industrial gases. Compressors can be split into two main groups, positive displacement and dynamic. Positive displacement compressors reduce the compression volume in the compression chamber to increase the pressure of fluid in the chamber.

Expansion of the gas occurs in blade tube 16 being convergent-divergent pinched in the middle. Tube compressor 24 being convergent-divergent pinched. Nozzle compressor 26 being convergent-divergent pinched in the middle. As the gas enters, blade tube 16, tube compressor 24, nozzle compressor 26 is moving at subsonic velocities.

### TECHNICAL FIELD

With means for generator axis 30 with circular motion causes generator 34 with means to produce electrical energy. Pressure air channel 32 with same circular motion causes generator axis 30 with same circular motion. Pressure air channel 32 component of generator axis 30. Generator 34 component of generator axis 30. With means for generator 34 with means to produce electrical energy and control amount of electric energy directly charge into battery 4.

With means for battery 4 with means to convert electrical energy directly into motor 6. With means for generator 34 with means to produce electrical energy into Motor 6. Motor axis 8 component of motor 6. Compressor hub 18 component of motor axis 8. With means for motor 6 with means to causes motor axis 8 with circular motion. Motor axis 8 with same circular motion causes compressor hub 18 with same circular motion. With means for generator 34 with means to produce electrical energy directly into generator motor 36. With means for generator motor 36 with means to causes generator motor axis 38 with circular motion. Generator motor axis 38 component of generator motor 36.

Air return housing 10 having one intake and having one or more outlet. Tube housing 12 having one or more intake. Tube housing 12 that are joined outlet into blade compressor 14 that are joined intake.

Air return housing 10 transporting air, fluid, or gas flows permitting stream into air tube housing 12 permitting stream into blade compressor 14. Blade compressor 14 having least three or more with each one having an intake and an outlet. Blade compressor 14 permitting stream into blade tube 16 being convergent-divergent pinched in the middle permitting stream accelerate into hub tube 20 permitting stream into housing air pressure 22 permitting stream into tube compressor 24 being convergent-divergent pinched in the middle permitting stream at having least three or more accelerate into nozzle compressor 26 being convergent-divergent pinched in the middle having permitting stream into gas tube 28 permitting stream into pressure air channel 32 permitting stream into air return housing 10.

Pressure air channel 32 with same circular motion causes generator axis 30 with same circular motion. With means for generator axis 30 with circular motion causes generator 34 with means to produce electrical energy. Pressure air channel 32 communication transporting air, fluid, or gas flows permitting stream into air tube housing 12. Air tube housing 12 component of air return housing 10.

Convergent-divergent type of nozzle: As the throat contracts, the gas is forced to accelerate until at the nozzle throat, where the cross-sectional area is the smallest, the axial velocity becomes sonic. From the throat the cross-sectional area then increases, the gas expands, and the axial velocity becomes progressively more than subsonic. Convergent-divergent type of nozzle: Communication transporting air, fluid, or gas flows permitting stream accelerate into blade tube 16 being convergent-divergent pinched in the middle, permitting stream accelerate into tube compressor 24 being convergent-divergent pinched in the middle, permitting stream at having least three or more accelerate into nozzle compressor 26 being convergent-divergent pinched in the middle.

### PRIMARY FUNCTION SUMMARY

Air return housing 10 having one intake and having one or more outlet. Tube housing 12 having one or more intake. Tube housing 12 that are joined outlet into blade compressor 14 that are joined intake. Air tube housing 12 that are joined outlet into blade compressor 14 having least three or more. Blade compressor 14 having least three or more with each one having an intake and an outlet. Housing air pressure 22 having least three or more that are joined intake and having least three or more that are joined outlet. Pressure air channel 32 having least one or more.

Pressure air channel 32 with same circular motion causes generator axis 30 with same circular motion. With means for generator axis 30 with circular motion causes generator 34 with means to produce electrical energy. With means for pressure air channel 32 component of generator axis 30. Generator 34 component of generator axis 30. With means for motor 6 with means to causes motor axis 8 with circular motion. Motor axis 8 with same circular motion causes compressor hub 18 with same circular motion. With means for generator 34 with means to produce electrical energy and control energy to motor 6. With means for generator 34 with means to produce electrical energy and control amount of electric energy directly charge into battery 4.

With means for battery 4 with means to convert electrical energy directly into motor 6. With means for generator 34 with means to produce electrical energy and control amount of electric energy directly into generator motor 36. With means for generator motor 36 with means to causes generator motor axis 38 with circular motion. Generator motor axis 38 component of generator motor 36.

Motor axis 8 component of motor 6. Air tube housing 12 component of air return housing 10. Compressor hub 18 component of motor axis 8. Blade compressor 14 component of blade tube 16 being convergent-divergent pinched in the middle. Hub tube 20 component of compressor hub 18. Blade compressor 14 having least three or more with each one having that are joined intake and that are joined outlet. Blade compressor 14 transporting air, fluid, or gas flows permitting stream into blade tube 16. Blade tube 16 transporting air, fluid, or gas flows permitting stream into hub tube 20.

Hub tube 20 transporting air, fluid, or gas flows permitting stream into housing air pressure 22. Housing air pressure 22 transporting air, fluid, or gas flows permitting stream into tube compressor 24 being convergent-divergent pinched in the middle permitting stream at having least three or more accelerate into nozzle compressor 26 being convergent-divergent pinched in the middle permitting stream accelerate into gas tube 28. Gas tube 28 transporting air, fluid, or gas flows permitting stream into pressure air channel 32.

Pressure air channel 32 transporting air, fluid, or gas flows permitting stream into air return housing 10. Air return housing 10 transporting air, fluid, or gas flows permitting stream into air tube housing 12. Air tube housing 12 transporting air, fluid, or gas flows permitting stream into blade compressor 14 having least three or more.

### Embodiment Information

Generator 34 AC or DC with means to produce electrical energy and control amount of electric charge into battery 4. Generator 34 AC or DC with means to produce electrical energy and control amount of electric into motor 6. Generator 34 AC or DC with means to produce electrical energy and control amount of electric to control into generator motor 36.

Convergent-divergent type of nozzle: Nozzles are used to modify the flow of a fluid (i.e., by increasing kinetic energy of the flow in expense of its pressure). Convergent-divergent type of nozzles; mostly used for supersonic flows because it is impossible to create supersonic flows in convergent type of nozzles and therefore it restricts us to a limited amount of mass flow through a particular nozzle. In convergent-divergent type of nozzles we can increase the flow velocity much higher than sonic velocity that is why these types of nozzles have a wide application such as propelling nozzles in jet engines or in fluid intake for engines working at high rpms. Convergent-divergent type of nozzles used in blade tube 16 being convergent-divergent pinched in the middle, tube compressor 24 being convergent-divergent pinched in the middle, and nozzle compressor 26 being convergent-divergent pinched in the middle.

The converging portion has a greater diameter than the diverging portion. The converging portion has a high capacity and a low velocity. The diverging portion will have a low capacity and a high velocity with a back pressure. The ambient pressure, referred to as lower atmospheric pressure, “back pressure” causes the fluid stream to accelerate. By reducing the pressure of the gases at the exit of the expansion portion, in effect, the molecules leave the outlets at their thermal speed without colliding with other molecules. This is because the molecules are all moving in the same relative direction and at the same speed. Converging and diverging portions used in the apparatus. Converging and diverging portions use in blade tube 16 being convergent-divergent pinched in the middle, tube compressor 24 being convergent-divergent pinched in the middle, and nozzle compressor 26 being convergent-divergent pinched in the middle.

A de Lava with nozzle (or convergent-divergent nozzle, CD nozzle or con-di nozzle) is a tube that is pinched in the middle, making a carefully balanced, asymmetric hourglass shape. In a subsonic flow sound will propagate through the gas. At the “throat”, where the cross-sectional area is at its minimum, the gas velocity locally becomes sonic (Mach number=1.0), a condition called choked flow. In a supersonic de Lava with nozzle: It is used to accelerate a hot, pressurized gas passing through it to a higher supersonic speed in the axial (thrust) direction, by converting the heat energy of the flow into kinetic energy. The de Lava with nozzle uses blade tube 16 being convergent-divergent pinched in the middle, tube compressor 24 being convergent-divergent pinched in the middle, and nozzle compressor 26 being convergent-divergent pinched in the middle.

### BRIEF DESCRIPTION OF THE DRAWINGS—List of COMPONENTS

List of Components: Battery 4, motor 6, motor axis 8, air return housing 10, air tube housing 12, blade compressor 14, blade tube 16, compressor hub 18, hub tube 20, housing air pressure 22, tube compressor 24, nozzle compressor 26, gas tube 28, generator axis 30, pressure air channel 32, generator 34, generator motor 36, generator motor axis 38.

FIG. 1: Components: battery 4—motor 6—motor axis 8—air return housing 10—air tube housing 12—compressor hub 18—hub—blade compressor 14—blade tube 16—tube 20—housing air pressure 22—tube compressor 24—nozzle compressor 26—gas tube 28—generator axis 30—pressure air channel 32—generator 34—generator motor 36—generator motor axis 38.

FIG. 2: Component: battery 4—motor 6—motor axis 8—blade compressor 14—blade tube 16—compressor hub 18—hub tube 20—housing air pressure 22—tube compressor 24—nozzle compressor 26—gas tube 28—generator axis 30—pressure air channel 32—generator 34—generator motor 36—generator motor axis 38.

FIG. 3: Components: Motor 6—motor axis 8—blade compressor 14—blade tube 16—compressor hub 18—hub tube 20—housing air pressure 22.

FIG. 4: Components: Compressor hub 18—hub tube 20—housing air pressure 22—tube compressor 24.

FIG. 5: Components: Tube compressor 24—nozzle compressor 26—gas tube 28—generator 34—generator motor 36—generator motor axis 38.

FIG. 6: Components: Air return housing 10—air tube housing 12—gas tube 28—generator axis 30—pressure air channel 32—generator 34—generator motor 36—generator motor axis 38.

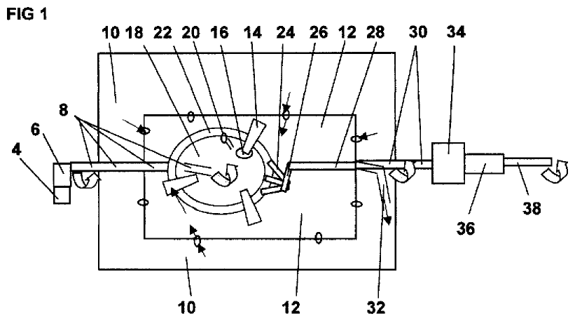

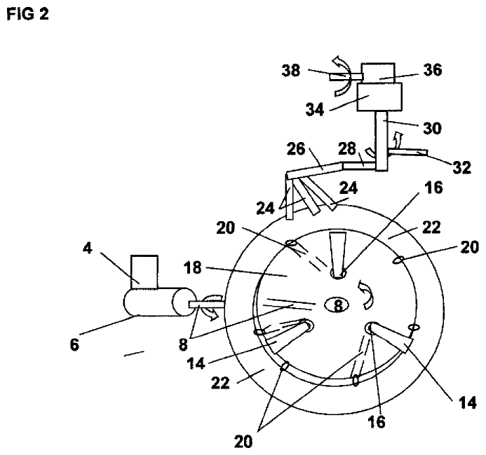

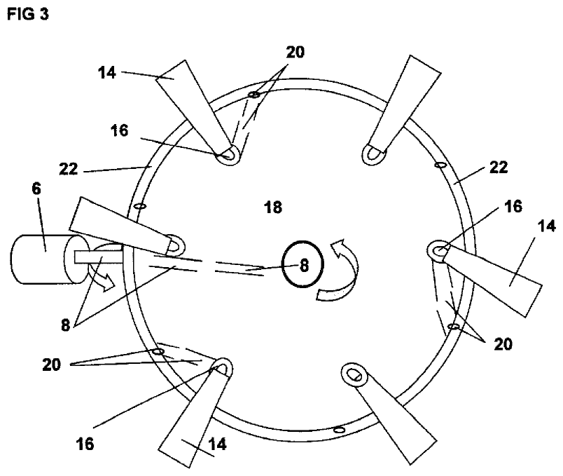

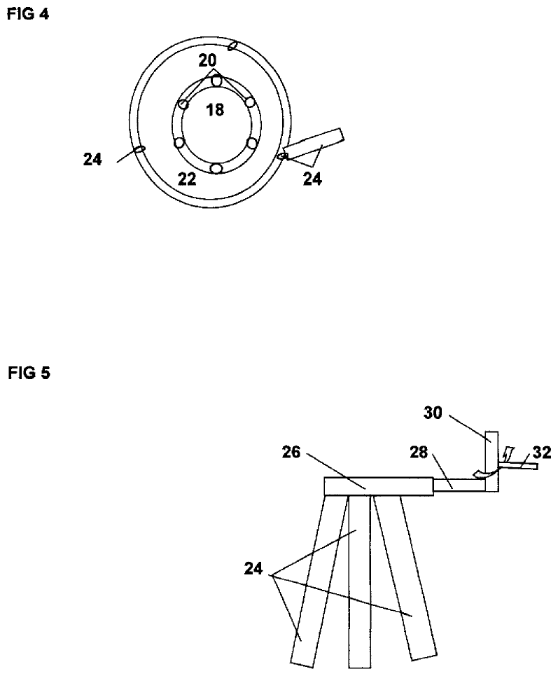

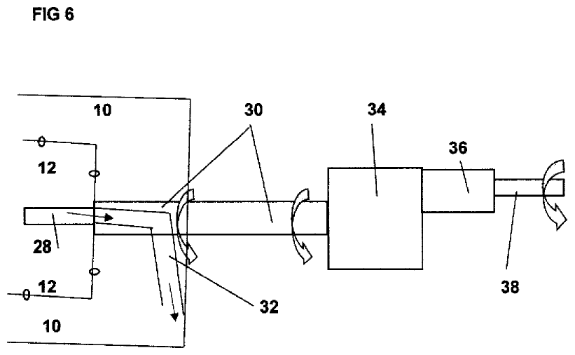

### DESCRIPTION OF THE PREFERRED EMBODIMENT

Battery 4 that remained stationary. With means for battery 4 with means to convert energy directly into motor 6. Motor 6 that remained stationary. With means for motor 6 with means to causes motor axis 8 with circular motion. With means for generator 34 with means to produce electrical energy and control amount of electric charge into motor 6. Motor axis 8 component of motor 6. Motor axis 8 component of motor 6. Motor axis 8 with same circular motion causes compressor hub 18 with same circular motion. Compressor hub 18 component of motor axis 8.

Air return housing 10 that remained stationary. Air return housing 10 having one intake and having one or more outlet. Pressure air channel 32 that are joined outlet into air return housing 10 that are joined intake. Pressure air channel 32 having that are joined outlet into air return housing 10 having that are joined intake.

Air tube housing 12 that remained stationary. Air tube housing 12 component of air return housing 10. Within component tube housing 12 are motor axis 8 component tube compressor 24 component nozzle compressor 26 component gas tube 28. Air tube housing 12 that are joined outlet into blade compressor 14 that are joined intake. Tube housing 12 having one or more intake.

Blade compressor 14 component of blade tube 16 being convergent-divergent pinched in the middle. Blade compressor 14 having least three or more with each one having that are joined intake and that are joined outlet. Blade compressor 14 that are joined outlet into blade tube 16 being convergent-divergent pinched in the middle that are joined intake. Blade tube 16 being convergent-divergent pinched in the middle component of hub tube 20. Blade tube 16 being convergent-divergent pinched in the middle that are joined outlet into hub tube 20 that are joined intake.

Compressor hub 18 component of motor axis 8. Hub tube 20 component of compressor hub 18. Hub tube 20 that are joined outlet into housing air pressure 22 that are joined intake. Housing air pressure 22 that remained stationary. Housing air pressure 22 having least three or more intake and having least three or more outlet. Housing air pressure 22 that are joined outlet into tube compressor 24 being convergent-divergent pinched in the middle that are joined intake.

Tube compressor 24 being convergent-divergent pinched in the middle that remained stationary. Tube compressor 24 being convergent-divergent pinched in the middle at having least three or more that are joined outlet into compressor 26 that are joined intake. Nozzle compressor 26 being convergent-divergent pinched in the middle that remained stationary. Nozzle compressor 26 being convergent-divergent pinched in the middle that are joined outlet into gas tube 28 that are joined intake.

Gas tube 28 that remained stationary. Gas tube 28 that are joined outlet into pressure air channel 32 that are joined intake. Generator axis 30 with circular motion causes generator 34 with means to produce electrical energy. Pressure air channel 32 component of generator axis 30. Pressure air channel 32 having least one or more with each one having that are joined intake and that are joined outlet. Pressure air channel 32 that are joined outlet into air return housing 10 that are joined intake. Pressure air channel 32 with same circular motion causes generator axis 30 with same circular motion.

Generator 34 that remained stationary. Generator 34 component of generator axis 30. With means for generator 34 with means to produce electrical energy and control amount of electric into generator motor 36. With means for generator 34 with means to produce electrical energy and control amount of electric charge into battery 4. Generator motor 36 that remained stationary. Generator motor axis 38 component of generator motor 36. With means for generator motor 36 with means to causes generator motor axis 38 with circular motion.

### Embodiment: In Different Forms

While the invention is susceptible to embodiment in many different forms, it will be understood that various modifications may be made to the embodiment disclosed herein. For example, dimensions may vary and are only approximations of a preferred embodiment, and any suitable fasteners may be utilized to operatively connect the various elements described herein. In addition, the nozzle, and its construction may be varied, as would be known in the art.

Likewise, the number and structure of the nozzle, etc. Also, the orientation of the nozzle, for example, they could be at a different angle than illustrated, or be in line with each other, as would be known to those of skill in the art. Therefore, the above description should not be construed as limiting, but merely as exemplifications of a preferred embodiment.

Those skilled in the art will envision other modifications within the scope, spirit, and intent of the invention as shown in the drawings and will be described to herein in detail, specific embodiments thereof with the understanding that the present disclosure is to be considered as an exemplification of the principles of the invention and is not to be limited to the specific embodiments described.

Each one of the examples is provided by way of explanation of the invention, not limitation of the invention. In fact, it will be apparent to those skilled in the art that various modifications and variations can be made in the present invention without departing from the scope or spirit of the invention.

For instance, features illustrated or described as component of one embodiment can be used same component with another other component to yield a still further embodiment.

Thus, it is intended that the present invention covers such modification and variations as come within the scope of the appended claims and their equivalents. Embodiments described with reference to accompanying figures, wherein like reference numbers designate corresponding or identical elements throughout the figures. It should be appreciated that the present invention is not limited to any type or style depicted in figures, for illustrative purposes only. It should be appreciated that the present invention is not limited to any type or style depicted in Figure's and is for illustrative purposes only.

### RAMIFICATIONS OF DETAILED DESCRIPTION

Although preferred embodiments have been depicted and described in detail therein, it will be apparent to those skilled in the relevant art that various modifications, additions, substitutions, and the like can be made without departing from the spirit of the invention and these are therefore considered to be within the scope of the invention as defined in the following claims. All air, fluid temperatures, pressurized gases, gases velocity or gases pressures used are an estimate, based on information attained.

Changes could be made without departing from essence present invention, by having other kinds of moving devices, such as using other kinds of motors, generator, axis, or multi-speed turbo motors to drive the air “fluid” stream. Having the motor, generator placed in other locations. Having the apparatus to use other kinds of air “gases” blower holes or volutes. Other kinds of power sources, like using solar energy. Use isolation material and formulation to reduce vibrations and dissipate shock energy for the blade, nozzle, and gases mover.

Changes could be made without departing from essence present invention, by having other kinds of nozzle, tube, with the subsonic de Lava nozzle: Like in determining the shape of the blade with nozzle in the Mach number. Like deflection in the blade and or the nozzle with prescribed geometry that includes inlet and exit nozzle angles, blade line and thickness distribution.

Other change could be having nozzle intake or outlet, placed higher or lower, smaller, or larger, more or less of them on the kinds of blades or nozzle. There are other kinds of convergent-divergent nozzle, or de Laval type nozzle or other kinds of nozzle with having one is a tube that is pinched in the middle, making an a carefully balanced, asymmetric shape.

What is claimed is:

1. An apparatus comprising: battery that remained stationary; with means for battery with means to convert to energy directly into motor; motor that remained stationary; with means for motor with means to causes motor axis with circular motion;
with means for generator with means to produce electrical energy and control amount of electric charge into motor; motor axis component of motor; motor axis with same circular motion causes compressor hub with same circular motion; compressor hub component of motor axis; air return housing that remained stationary; air return housing having one intake and having one or more outlet; pressure air channel that are joined outlet into air return housing that are joined intake; air tube housing that remained stationary; air tube housing component of air return housing; within component tube housing are motor axis component tube compressor component nozzle compressor component gas tube; air tube housing that are joined outlet into blade compressor that are joined intake; tube housing having one or more intake; blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube component of compressor hub; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake; tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary; nozzle compressor being convergent-divergent pinched in the middle that are joined outlet into gas tube that are joined intake; gas tube that remained stationary; gas tube that are joined intake and that are joined outlet; gas tube that are joined outlet into pressure air channel that are joined intake; generator axis with circular motion causes generator with means to produce electrical energy; pressure air channel component of generator axis;
pressure air channel having least one or more with each one having that are joined intake and that are joined outlet; pressure air channel that are joined outlet into air return housing that are joined intake; pressure air channel with same circular motion causes generator axis with same circular motion; generator that remained stationary;
generator component of generator axis; with means for generator with means to produce electrical energy and control amount of electric into generator motor;
with means for generator with means to produce electrical energy and control amount of electric charge into battery; generator motor that remained stationary; generator motor axis component of generator motor; with means for generator motor with means to causes generator motor axis with circular motion; generator motor that remained stationary; generator motor axis component of generator motor.

2. An apparatus comprising of claim 1, wherein comprising: battery that remained stationary; with means for battery with means to convert energy directly into motor;
motor that remained stationary; with means for motor with means to causes motor axis with circular motion; with means for generator with means to produce electrical energy and control amount of electric charge into motor; motor axis component of motor; motor axis with same circular motion causes compressor hub with same circular motion;
compressor hub component of motor axis; air return housing that remained stationary;
air return housing having one intake and having one or more outlet; pressure air channel that are joined outlet into air return housing that are joined intake; air tube housing that remained stationary; air tube housing component of air return housing;
within component tube housing are motor axis component tube compressor component nozzle compressor component gas tube; air tube housing that are joined outlet into blade compressor that are joined intake; tube housing having one or more intake; blade compressor component of blade tube being convergent-divergent pinched in the middle;
blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube component of compressor hub; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake;
tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary;
nozzle compressor being convergent-divergent pinched in the middle that are joined outlet into gas tube that are joined intake; gas tube that remained stationary; gas tube that are joined intake and that are joined outlet; gas tube that are joined outlet into pressure air channel that are joined intake; generator axis with circular motion causes generator with means to produce electrical energy; pressure air channel component of generator axis; pressure air channel having least one or more with each one having that are joined intake and that are joined outlet; pressure air channel that are joined outlet into air return housing that are joined intake; pressure air channel with same circular motion causes generator axis with same circular motion; generator that remained stationary; generator component of generator axis.

3. An apparatus comprising of claim 1, wherein comprising: battery that remained stationary; with means for battery with means to convert energy directly into motor;
motor that remained stationary; with means for motor with means to causes motor axis with circular motion; motor axis component of motor; motor axis with same circular motion causes compressor hub with same circular motion; compressor hub component of motor axis; air return housing that remained stationary; air return housing having one intake and having one or more outlet; pressure air channel that are joined outlet into air return housing that are joined intake; air tube housing that remained stationary; air tube housing component of air return housing; within component tube housing are motor axis component tube compressor component nozzle compressor component gas tube air tube housing that are joined outlet into blade compressor that are joined intake; tube housing having one or more intake; blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube component of compressor hub; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake; tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary; nozzle compressor being convergent-divergent pinched in the middle that are joined outlet into gas tube that are joined intake; gas tube that remained stationary; gas tube that are joined intake and that are joined outlet; gas tube that are joined outlet into pressure air channel that are joined intake; pressure air channel component of generator axis; generator axis with circular motion; pressure air channel having least one or more with each one having that are joined intake and that are joined outlet; pressure air channel that are joined outlet into air return housing that are joined intake; pressure air channel with same circular motion causes generator axis with same circular motion.

4. An apparatus comprising of claim 1, wherein comprising: motor that remained stationary; with means for motor with means to causes motor axis with circular motion;
motor axis component of motor; motor axis with same circular motion causes compressor hub with same circular motion; compressor hub component of motor axis;
air return housing that remained stationary; air return housing having one intake and having one or more outlet; pressure air channel that are joined outlet into air return housing that are joined intake; air tube housing that remained stationary; air tube housing component of air return housing; within component tube housing are motor axis component tube compressor component nozzle compressor component gas tube; air tube housing that are joined outlet into blade compressor that are joined intake; tube housing having one or more intake; blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake;
tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary;
nozzle compressor being convergent-divergent pinched in the middle that are joined outlet into gas tube that are joined intake; gas tube that remained stationary; gas tube that are joined intake and that are joined outlet.

5. An apparatus comprising of claim 1, wherein comprising: motor axis with same circular motion causes compressor hub with same circular motion; compressor hub component of motor axis; air tube housing that remained stationary; within component tube housing are motor axis component tube compressor component nozzle compressor component gas tube; air tube housing that are joined outlet into blade compressor that are joined intake; tube housing having one or more intake; blade compressor component of blade tube being convergent-divergent pinched in the middle;
blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube component of compressor hub; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake;
tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary;
nozzle compressor being convergent-divergent pinched in the middle that are joined outlet into gas tube that are joined intake; gas tube that remained stationary; gas tube that are joined intake and that are joined outlet; gas tube that are joined outlet into pressure air channel that are joined intake.

6. An apparatus comprising of claim 1, wherein comprising: motor that remained stationary; with means for motor with means to causes motor axis with circular motion;
motor axis component of motor; motor axis with same circular motion causes compressor hub with same circular motion; compressor hub component of motor axis;
blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake;
blade tube being convergent-divergent pinched in the middle component of hub tube;
blade tube being convergent-divergent pinched in the middle that are joined outlet into hub tube that are joined intake; hub tube that are joined outlet.

7. An apparatus comprising of claim 1, wherein comprising: motor that remained stationary; with means for motor with means to causes motor axis with circular motion;
motor axis component of motor; motor axis with same circular motion causes compressor hub with same circular motion; compressor hub component of motor axis;
blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake;
blade tube being convergent-divergent pinched in the middle component of hub tube;
blade tube being convergent-divergent pinched in the middle that are joined outlet into hub tube that are joined intake; hub tube that are joined outlet into housing air pressure that are joined intake; housing air pressure that remained stationary; housing air pressure having least three or more intake and having least three or more outlet;
housing air pressure that are joined outlet.

8. An apparatus comprising of claim 1, wherein comprising: motor that remained stationary; with means for motor with means to causes motor axis with circular motion;
motor axis component of motor; motor axis with same circular motion causes compressor hub with same circular motion; compressor hub component of motor axis;
blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake;
blade tube being convergent-divergent pinched in the middle component of hub tube;
blade tube being convergent-divergent pinched in the middle that are joined outlet into hub tube that are joined intake; hub tube that are joined outlet into housing air pressure that are joined intake; housing air pressure that remained stationary; housing air pressure having least three or more intake and having least three or more outlet;
housing air pressure that are joined outlet into tube compressor being convergent-divergent pinched in the middle that are joined intake; tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary; nozzle compressor being convergent-divergent pinched in the middle that are joined outlet.

9. An apparatus comprising of claim 1, wherein comprising: battery that remained stationary; with means for battery with means to convert energy directly into motor;
motor that remained stationary; with means for motor with means to causes motor axis with circular motion; with means for generator with means to produce electrical energy and control amount of electric charge into motor; motor axis component of motor; motor axis with same circular motion causes compressor hub with same circular motion;
compressor hub component of motor axis; blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake;
tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary;
nozzle compressor being convergent-divergent pinched in the middle that are joined outlet into gas tube that are joined intake; gas tube that remained stationary; gas tube that are joined outlet into pressure air channel that are joined intake; generator axis with circular motion causes generator with means to produce electrical energy; pressure air channel component of generator axis; pressure air channel having least one or more with each one having that are joined intake and that are joined outlet; pressure air channel that are joined outlet into air return housing that are joined intake; pressure air channel with same circular motion causes generator axis with same circular motion;
generator that remained stationary; generator component of generator axis.

10. An apparatus comprising of claim 1, wherein comprising: battery that remained stationary; with means for battery with means to convert energy directly into motor; motor that remained stationary; with means for motor with means to causes motor axis with circular motion; with means for generator with means to produce electrical energy and control amount of electric charge into motor; motor axis component of motor; motor axis with same circular motion causes compressor hub with same circular motion; compressor hub component of motor axis; blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake; tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary; nozzle compressor being convergent-divergent pinched in the middle that are joined outlet into gas tube that are joined intake; gas tube that remained stationary; gas tube that are joined outlet into pressure air channel that are joined intake; generator axis with circular motion causes generator with means to produce electrical energy; pressure air channel component of generator axis; pressure air channel having least one or more with each one having that are joined intake and that are joined outlet; pressure air channel that are joined outlet into air return housing that are joined intake; pressure air channel with same circular motion causes generator axis with same circular motion; generator that remained stationary; generator component of generator axis; generator motor that remained stationary; generator motor axis component of generator motor; with means for generator motor with means to causes generator motor axis with circular motion; generator motor that remained stationary;
generator motor axis component of generator motor.

11. An apparatus comprising of claim 1, wherein comprising: gas tube that remained stationary; gas tube that are joined intake and that are joined outlet; into pressure air channel that are joined intake; air channel that are joined intake; pressure air channel component of generator axis; pressure air channel having least one or more with each one having that are joined intake and that are joined outlet; pressure air channel that are joined outlet; pressure air channel with same circular motion causes generator axis with same circular motion.

12. An apparatus comprising of claim 1, wherein comprising: air channel that are joined intake; pressure air channel component of generator axis; pressure air channel having least one or more with each one having that are joined intake and that are joined outlet; pressure air channel that are joined outlet; pressure air channel with same circular motion causes generator axis with same circular motion.

13. An apparatus comprising of claim 1, wherein comprising: compressor hub component of motor axis; blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube that are joined outlet into housing air pressure that are joined intake; housing air pressure that remained stationary; housing air pressure having least three or more intake and having least three or more outlet; housing air pressure that are joined outlet into tube compressor being convergent-divergent pinched in the middle that are joined intake;
tube compressor being convergent-divergent pinched in the middle that remained stationary; tube compressor being convergent-divergent pinched in the middle at having least three or more that are joined outlet into compressor that are joined intake; nozzle compressor being convergent-divergent pinched in the middle that remained stationary;
nozzle compressor being convergent-divergent pinched in the middle that are joined outlet.

14. An apparatus comprising of claim 1, wherein comprising: blade compressor component of blade tube being convergent-divergent pinched in the middle; blade compressor having least three or more with each one having that are joined intake and that are joined outlet; blade compressor that are joined outlet into blade tube being convergent-divergent pinched in the middle that are joined intake; blade tube being convergent-divergent pinched in the middle component of hub tube; blade tube being convergent-divergent pinched in the middle that are joined outlet into hub tube that are joined intake; hub tube component of compressor hub: hub tube that are joined intake and outlet that are joined outlet.

15. An apparatus comprising of claim 1, wherein comprising: housing air pressure that remained stationary; housing air pressure having least three or more intake and having least three or more outlet; housing air pressure that are joined outlet into tube compressor being convergent-divergent pinched in the middle that are joined intake;
tube compressor being convergent-divergent pinched in the middle that remained stationary; tube compressor being convergent-divergent pinched in the middle at having least three or more that are joined intake outlet and that are joined outlet.

16. An apparatus comprising of claim 1, wherein comprising: tube compressor being convergent-divergent pinched in the middle that remained stationary; tube compressor being convergent-divergent pinched in the middle at having least three or more that are joined outlet into compressor being convergent-divergent pinched in the middle that are joined intake; nozzle compressor being convergent-divergent pinched in the middle that remained stationary; nozzle compressor being convergent-divergent pinched in the middle that are joined intake and that are joined outlet.
